(19) United States
(12) Patent Application Publication
(10) Pub. No.: US 2025/0196320 A1
(43) Pub. Date: Jun. 19, 2025

(54) ANKLE-ASSISTING EXOSKELETON SUPPORT

(71) Applicant: YROBOT (SUZHOU) CO., LTD., Suzhou City, Jiangsu Province (CN)

(72) Inventors: YE DING, Suzhou City, Jiangsu Province (CN); BENJAMIN PROTEUS, Cambridge City, MA (US); XINHUI LI, Suzhou City, Jiangsu Province (CN); TAO SUN, Suzhou City, Jiangsu Province (CN); CAN WANG, Suzhou City, Jiangsu Province (CN)

(21) Appl. No.: 18/835,995

(22) PCT Filed: Dec. 9, 2022
(86) PCT No.: PCT/CN2022/138032

§ 371 Date: Aug. 5, 2024

(30) Foreign Application Priority Data
Apr. 7, 2022 (CN) 202210361494.0

(51) Int. Cl. B25J 9/00; A61H 3/00

(52) U.S. Cl. CPC B25J 9/0006; A61H 3/00; A61H 2201/1642; A61H 2201/165

(57) ABSTRACT

An ankle-assisting exoskeleton support includes an upper bracket and a lower bracket. The lower end of the upper bracket is rotatably connected with the rear end of the lower bracket. The upper bracket is fixed to the lower leg by a connecting belt used for being arranged to wrap around the lower human leg. The upper end of the upper bracket is located on the outer side of the lower human leg and is located below the knee. The lower bracket is arranged to warp around the human foot and assist in dorsiflexion and plantarflexion of the human foot. The upper bracket comprises a body. The upper end of the body extends upwards and outwards to form a pair of upper inner and outer brackets with radians. The lower end of the body extends downwards and outwards to form a pair of lower inner and outer brackets with radians.

### CROSS-REFERENCE TO RELATED APPLICATIONS

This application claims priority to Chinese Patent Application No. 202210361494.0, filed on Apr. 7, 2022, the entire disclosure of which is hereby incorporated by reference in its entirety.

### TECHNICAL FIELD

This invention relates to the technical field of wearable devices, and in particular, to an ankle-assisting exoskeleton support that provides auxiliary force for a user's ankle and can be used daily.

### BACKGROUND

Currently, wearable devices for lower limbs are designed for different purposes, including wearable devices that enhance human strength, provide rehabilitation training, improve mobility efficiency, and reduce human energy consumption. For human strength and rehabilitation purposes, wearable lower limb devices or exoskeletons often rely on full-leg rigid metal structures to provide external body support. These lower limb exoskeleton systems enable able-bodied people or people with physical disabilities to perform tasks that would be impossible using their own strength. For example, the existing US201380064944.9 discloses a rigid exoskeleton bracket. The structure of the bracket provides a bracket structure in which thigh links, calf links, and foot links cooperate with the human body. However, existing rigid wearable devices have the following shortcomings in coordinating human actions and improving movement efficiency: (1) Interference between the device and biological joints occurs due to misalignment of device joints with human joints during movement; (2) The degree of freedom of movement of biological joints is restricted because the degree of freedom of the device is less than that of the joints of the human lower limbs; (3) Due to the large weight and inertia that are not fully controlled and compensated by the device itself, the user needs to pay extra energy to drive part of the device when wearing the device. At the same time, the heavier and larger device structure also makes it difficult for such full-leg rigid exoskeleton device to be used in daily life scenarios.

Currently, some soft exoskeleton devices are made of lightweight soft materials to reduce constraints on biological joints and provide joint assistance. Such devices present a lighter solution for assisting joints. But these soft exoskeleton devices rely on the user's skin surface to provide tangential force as a reaction force to assist the joint. That is, these devices provide auxiliary force to the user's limb joints on one side, and applying tangential forces tangential to the user's skin surface on the other side. These tangential forces cause the user's skin surface to be rubbed, squeezed, and thereby causing discomfort to the user. Moreover, when the user's skin is loose and the muscle stiffness is insufficient, making it difficult to provide a large enough tangential force as a reaction force to the auxiliary force, these devices will not be able to provide sufficient auxiliary force.

Therefore, there is an urgent need for an exoskeleton support that is lightweight, easy to wear, easy to adjust or does not constrain the user's joints, and a wearable assistive support that does not rely on the user's skin surface to provide tangential force while providing lower limb assistance to improve users' daily mobility and efficiency.

In view of this, the present invention is proposed.

### SUMMARY

The purpose of the present invention is to provide an ankle-assisting exoskeleton support that is lightweight, does not restrict the freedom of the user's joints, and better matches the human body.

The invention provides an ankle-assisting exoskeleton support, which includes an upper bracket and a lower bracket; the lower end of the upper bracket is rotatably connected to the rear end of the lower bracket, and the upper bracket is fixed to the calf through a connecting belt for being mounted on the calf of the human body, the upper end of the upper bracket is located on the inner and outer sides of the human calf and below the knee; the lower bracket is set on the human foot to provide assistance for the dorsiflexion and plantar flexion movement of the human foot;

The upper bracket includes a body, a pair of upper inner and outer brackets with curvature extend upward and outward from the upper end of the body; a pair of lower inner and outer brackets with curvature extend downward and outward from the lower end of the body, the upper bracket forms an X-shaped bracket structure with bending curvature.

The preferred solution is that the bending curvature of the upper bracket is defined as follows: the maximum bending point is located on the body, the upper end point of the upper inner and outer brackets is located at the middle and rear position of the inner and outer sides of the calf when the user wears it; the lower end point of the lower inner and outer bracket is located at the user's ankle joint position or on the axis of dorsiflexion and plantar flexion degrees of freedom when the user is using it.

Another preferred solution is that the upper bracket is integrally formed, and its bending curvature is: the distance from the lowermost end to the uppermost end of the upper bracket is 20 cm-50 cm, preferably 30 cm-40 cm, and more preferably 36 cm; the distance between the middle part of the main body and the straight line connecting the uppermost end and the lower end of the upper bracket is 5 cm-15 cm, preferably 8 cm-12 cm, and more preferably 10 cm.

Another preferred solution is that the lower bracket includes a front inner and outer support arm and a heel support arm, the heel support arm is in a U shape matching the shape of the human heel, the two ends of the U shape are connected to the rear ends of the front inner and outer support arms. The intersection point of the heel support arm and the front inner and outer support arms is the connection point between the lower bracket and the upper bracket, forming the joint rotation part of the exoskeleton support.

Another preferred solution is that the lower bracket includes a foot strap, and the two ends of the foot strap are respectively fixedly connected to the front and inner support arms of the lower bracket, and are located on the instep of the human foot to support, position, and fix the user's feet; the front end of the front and inner and outer support arms of the lower bracket each extends inwardly with a convex thin support piece, which is located on the sole of the user's shoe to support, position and fix the user's foot, and when the lower bracket rotates and swings upwards and downwards, respectively providing upward support thrust to the user's feet and downward pressure to the ground.

Another preferred solution is that the lower bracket further includes a heel strap located under the heel of the human body, the heel strap is in the shape of a sheet, and its two ends are connected to the rear positions of the front, inner and outer support arms or to the U-shaped two ends of the heel support arm may be connected to the connection between the heel support arm and the front inner and outer support arms.

Another preferred solution is that a baffle extends downward from both ends of the U-shape of the heel support arm, and the heel strap is connected to the lower ends of the two baffles.

Another preferred solution is that ankle-assisting exoskeleton support also includes a heel connection cover, which extends downward from the center point of the heel support arm and includes a U-shaped thin plate that abuts on the sole of the user's heel.

Another preferred solution is that the rotation part realizes the relative free rotation and reset of the upper and lower brackets, and includes an outer bearing seat, a torsion spring, an inner bearing seat, a bearing, and a bearing cover; the outer bearing seat is fixed to the outer side of the lower end of the upper bracket, the torsion spring, inner bearing seat, bearing, and bearing cover are installed in sequence between the inside of the lower end of the upper bracket and the lower bracket.

Another preferred solution is that the body of the upper bracket is provided with an installation portion for installing and fixing the traction cable; and the heel support arm of the lower bracket is provided with an installation portion for installing and fixing the traction cable.

The present invention provides a curved upper support structure by arranging a curved upper bracket structure, the present invention reduces the height of the overall structure of the support, and better cooperates with the human body, there are no parts on the side of the human body's calf, which reduces the possibility of collision, does not affect other activities when worn, and enhances the wearing experience and comfort.

The upper bracket of the X structure of the present invention is formed in one piece, which reduces the connection between the components and improves the strength of the overall structure; at the same time, the upper and lower inner and outer brackets can be made thinner and smaller to withstand the force, reducing materials, weight, and cost; at the same time, the X-shaped structure is symmetrical, and the force generated on the bracket and the assistance provided by the bracket are symmetrical, achieving a better balanced assistance effect. The traction cables and/or transmission lines of the exoskeleton equipment are connected and fixedly positioned through the body of the X structure, so that the traction cables and/or transmission lines are located behind the calf, which improves the structural compactness and simplicity of the overall exoskeleton support.

### BRIEF DESCRIPTION OF DRAWINGS

In order to more clearly explain the embodiments of the present application or the technical solutions in the prior art, the drawings needed to be used in the description of the embodiments or the prior art will be briefly introduced below, obviously, the drawings in the following description are some embodiments of the present application, for ordinary technicians in this field, other drawings can be obtained based on these drawings without exerting creative efforts.

FIG. 1 is a schematic perspective view of an ankle-assisting exoskeleton support in one embodiment of the present invention;

FIG. 2 is an exploded schematic diagram of a partial structure of the exoskeleton support shown in FIG. 1;

FIG. 3 is a schematic diagram showing the distance between the connection points of the traction cables of the ankle-assisting exoskeleton support and the lower bracket in one embodiment of the present invention;

FIG. 4 is a schematic diagram of the leg strap of the ankle-assisting exoskeleton support in one embodiment of the present invention;

FIG. 5 is a three-dimensional schematic diagram of the use state of the leg strap of the ankle-assisting exoskeleton support in FIG. 4;

FIG. 6 is a schematic diagram of a protective pad for leg strap in one embodiment of the present invention;

FIG. 7 is a schematic diagram of the foot strap of the ankle-assisting exoskeleton support in one embodiment of the present invention;

FIG. 8 is a three-dimensional exploded schematic view of the cable installation portion of the upper bracket in an embodiment of the present invention;

FIG. 9 is a three-dimensional exploded schematic view of the cable installation portion of the lower bracket in an embodiment of the present invention;

FIG. 10 is a schematic diagram of various reaction forces generated during the use of the ankle-assisting exoskeleton support in the present invention;

FIG. 11 is a partially enlarged and exploded schematic view of one end of the torsion spring and the lower bracket fixing structure in FIG. 2;

FIG. 12 is a partially enlarged and exploded schematic view of the other end of the torsion spring and the upper bracket fixing structure in FIG. 2;

FIG. 13 is a partially enlarged and exploded schematic view of the fixing structure of the inner bearing seat and the upper bracket in FIG. 2.

### DESCRIPTION OF EMBODIMENTS

The directions of up, down, left, right, front and back mentioned in the present invention are based on the up, down, left, right, front and back directions of the human body. The inner and outer directions are based on the inner and outer directions of the human body's legs.

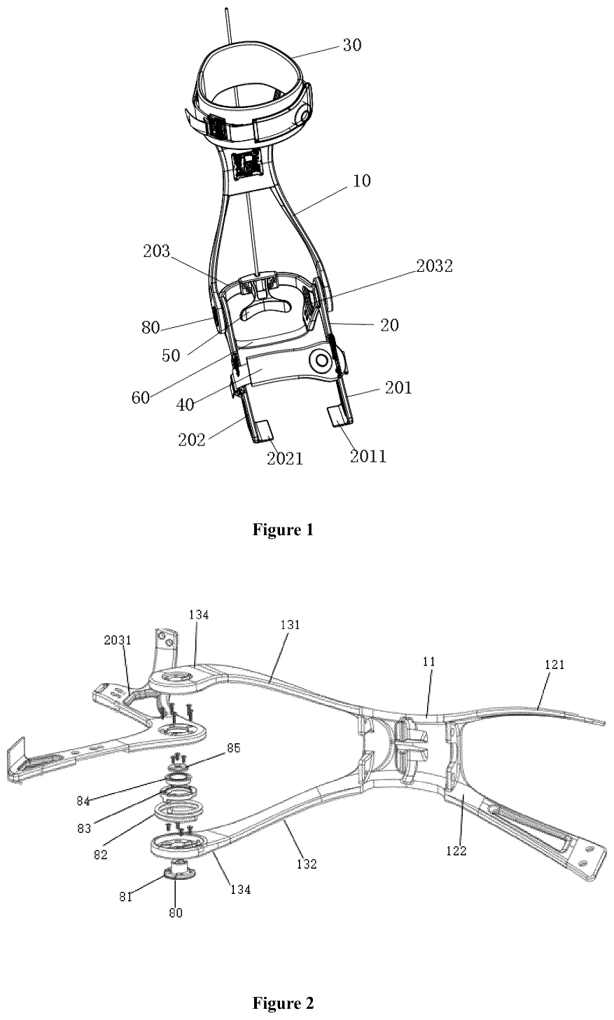

As shown in FIGS. 1 and 2, the ankle-assisting exoskeleton support of the present invention is suitable for use in wearable devices that assist in the rehabilitation of lower limb motor functions and is light in weight. The ankle-assisting exoskeleton support includes: an upper bracket 10 and a lower bracket 20, leg strap 30, foot strap 40, heel connection cover 50, heel strap 60. The lower end of the upper bracket 10 is rotatably connected to the rear end of the lower bracket 20. The upper end of the upper bracket 10 is connected to the leg strap 30. When in use, the leg strap 30 is worn on the human calf, and the upper bracket is fixed on the human calf. The foot strap 40 is connected to the front end of the lower bracket 20. The foot strap 40 is worn on the instep of human foot when in use. The heel strap 60 is connected to the rear end of the lower bracket 20. The heel strap 60 is located below the human heel when in use. The upper bracket 10 and lower bracket 20 components are worn on the lower limb of the human body through the leg strap 30, the foot strap 40 and the heel strap 60.

The upper bracket 10 includes a body 11, a pair of upper inner and outer brackets 121 and 122 with curvature extend upward and outward from the upper end of the body, a pair of lower inner and outer brackets 131 and 132 with curvature extend downward and outward from the lower end of the body 11, and the upper bracket 10 forms an X-shaped bracket structure. The ends of the upper inner and outer brackets 121 and 122 are provided with upper connection portion (not numbered) connected to the leg straps 30, the ends of the lower inner and outer brackets 131 and 132 are provided with lower connection portion 134 connected to the lower bracket 20. In a preferred solution, the X-shaped upper bracket 10 is an integrally formed structure and is made of lightweight carbon fiber. The upper bracket 10 has a non-linear shape and is arranged in a curved shape with a certain curvature bent toward the direction of the human body's calf. The bending curvature of the upper bracket 10 is defined as follows: the maximum curvature point is located at the position of the body 11, and the upper end points of the upper inner and outer brackets 121 and 122 are located at the middle and back position of the inner and outer sides of the calf when worn by the user, this position setting point is better to choose a position that avoids collision between the outside and the bracket when the user uses it and is not affected when bending the legs; the lower end points of the lower inner and outer brackets 131 and 132 are located at the user's ankle joint position or on the axis of dorsiflexion and plantar flexion degrees of freedom when the user is using it. In this embodiment, the distance from the lowermost end to the uppermost end of the upper bracket 10 is 20 cm-50 cm, preferably 30 cm-40 cm, and more preferably 36 cm; connect the uppermost end and the lower end, and the distance between the middle part of the rear X-shaped body 11 and the connecting lines is 5 cm-15 cm, preferably 8 cm-12 cm, and more preferably 10 cm. This arrangement of the structure of the curved upper bracket 10 reduces the height of the overall structure of the bracket and better matches the human body, there are no parts on the side of the human calf, which reduces the possibility of collision and does not affect other activities when worn, enhances wearing experience and comfort. The upper bracket 10 of the X structure in the present invention is integrally formed to reduce the connections between the components and improve the strength of the overall structure; at the same time, the upper and lower inner and outer brackets can be made thinner and smaller to also achieve the same ability to withstand the force, reduce materials, reduce weight, and reduce costs; at the same time, the X-shaped structure is symmetrical, and the force generated on the bracket and the assistance provided by the bracket are symmetrical, achieving a better balanced assistance effect. The body 11 at the intersection of the upper bracket 10 of the X structure provides a mounting and fixing platform for other components such as traction cables and/or transmission lines, sensors, processors, controllers and other components, all the other components are assembled and installed on the body 11; the traction cables and/or transmission lines of the skeletal equipment are connected and fixedly positioned through the body 11 of the X structure, so that the traction cables and/or transmission lines are located behind the calf, making the structure of the overall exoskeleton support more compact and concise.

The lower bracket 20 includes front inner and outer support arms 201, 202 and a heel support arm 203, the heel support arm 203 is U-shaped to match the shape of the human heel, the two ends of the U shape are in contact with the rear ends of the front inner and outer support arms 201, 202. In the embodiment of the present invention, the intersection point of the front inner and outer support arms 201, 202 and the upper bracket 134 is the connection point between the lower bracket 20 and the upper bracket 10, which is the joint rotation part 80 of the exoskeleton support.

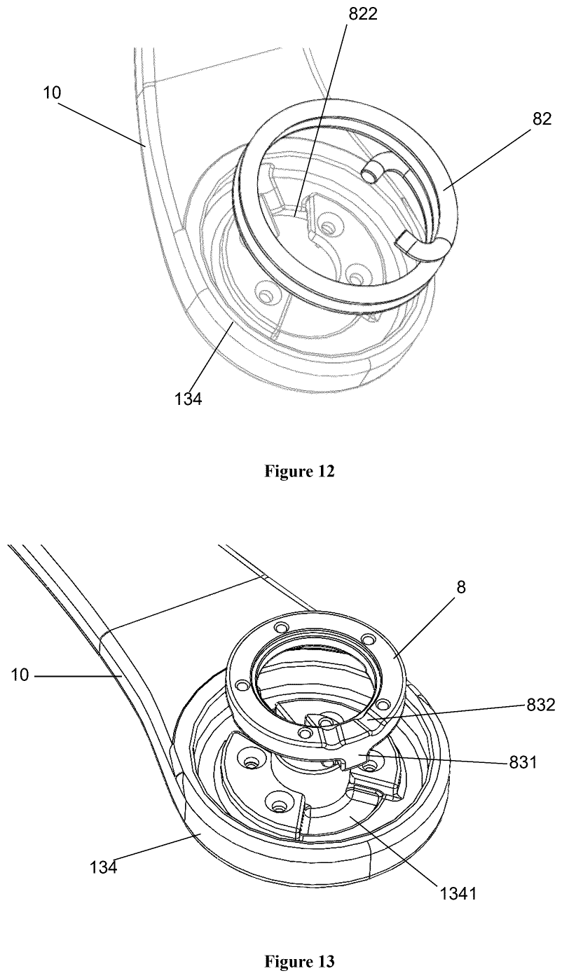

The rotation part 80 realizes the relative free rotation movement and reset of the upper and lower brackets 10 and 20, and includes an outer bearing seat 81, a torsion spring 82, an inner bearing seat 83, a bearing 84, and a bearing cover 85. The installation sequence is as follows: the outer bearing seat 81 is fixed on the outside of the mounting hole at the lower end of the upper bracket 10, the torsion spring 82, the inner bearing seat 83, the bearing 84, and the bearing cover 85 are sequentially installed between the mounting hole at the lower end of the upper bracket 10 and the mounting hole of the lower bracket 20. The outer bearing seat 81, the inner bearing seat 83, the bearing 84 and the bearing cover 85 assemble the upper and lower brackets 10 and 20 together to achieve the relative free rotation of the upper and lower brackets, in this embodiment, they are fixed by screws. Please refer to FIGS. 11, 12, and 13 at the same time, the inner bearing seat 83 is provided with a protrusion 831, and the lower connecting portion 134 of the upper bracket 10 is provided with a limiting groove 1341 for the protrusion 831, the protrusion 831 moves within the limiting groove 1341 to limit the rotation of the upper and lower brackets 10 and 20 within a certain range, the limiting groove 1341 limits the movement of the protrusion 831 within a certain range, thereby achieving adjustment and control of the lower bracket 20 rotating within the rotation range of the human body's ankle joint, thereby protecting the human body's ankle joint. The connecting portion of the lower bracket 20 is provided with a torsion spring slot 821, and the lower connecting portion 1341 of the upper bracket 10 is provided with a torsion spring slot 822. The two ends of the torsion spring 82 are respectively fixed to in the torsion spring slots 822 and 821 of the upper and lower brackets' connecting portion.

In another embodiment, the inner bearing seat 83 is provided with a fixing groove 832 on the other side opposite to the side of the protrusion 831, which is used to fix the bending angle of one end of the torsion spring 82, part of the bending foot is fixed on the fixing groove 832 of the inner bearing seat 83, and another part of the bending foot is fixed on the torsion spring slot 821 of the lower limb bracket 20, the fixing groove 832 cooperates with the torsion spring slot 821 of the lower bracket 20 to stabilize and fix the torsion spring 82.

The lower connection portion of the lower inner and outer brackets of the upper bracket 10 are respectively connected to the connection part of the lower bracket 20 to form internal and external joint rotation parts that match the human ankle joint. Each joint rotation part is equipped with the above-mentioned outer bearing seat 81, torsion spring 82, inner bearing seat 83, bearing 84, bearing cover 85 components and corresponding installation structures.

In this embodiment, the outer bearing seat 81, the bearing 84, the inner bearing seat 83 and the bearing cover 85 assemble the upper and lower brackets 10 and 20 together, and are locked by screws to realize the relative free rotation of the upper and lower brackets.

The torsion spring 82 is fixed by the mechanical limit and reset structure of the torsion spring slots of the upper and lower brackets 10 and 20, the torsion spring 82 generates torsion as the upper and lower brackets 10 and 20 rotate and twist with each other, thereby assisting the upper and lower brackets reset, effectively improves the power assist. The torsion spring reset structure: when the bracket is in an unloaded state, the upper bracket 10 and the lower bracket 20 are at the maximum angle of dorsiflexion, and the spring 82 is in a natural state, when the bracket starts to rotate, the torsion spring 82 starts to deform, and the generated torsion force can restore the bracket to its unloaded state after the external load is lost, that is, when the heel support arm 203 of the lower bracket 20 is pulled up by the traction cable, the pulling force will cause the heel support arm 203 to begin to twist and deform the spring 82, when the cable is relaxed, the deformed torsion spring 82 returns the bracket to its original position.

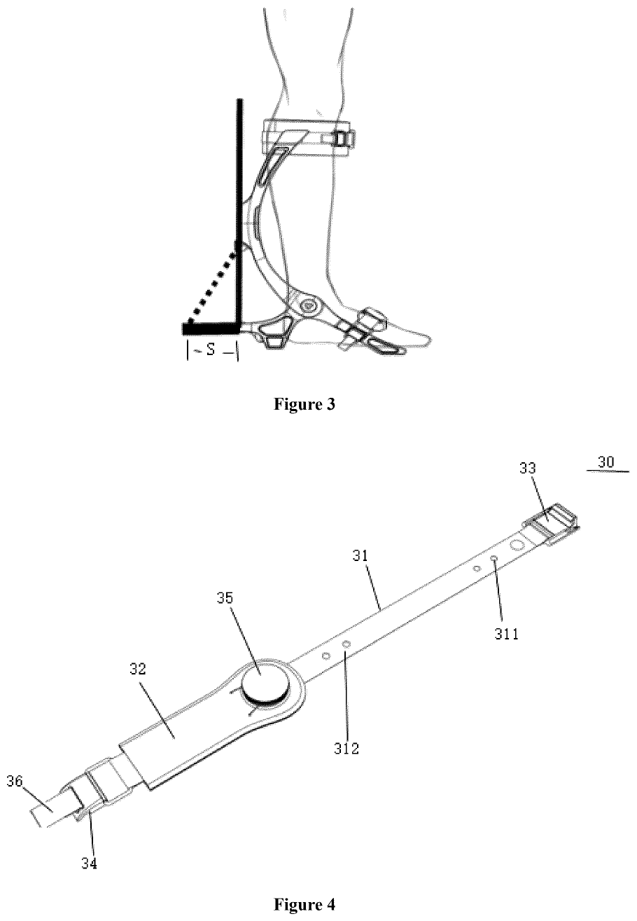

A cable fixing part 204 is provided on the heel support arm 203 for fixing the traction cable and/or transmission line. The cable fixing part 204 is located in the middle of the heel support arm 203 so that the traction cable is fixed on the heel support arm 203 in the middle position to provide a balanced pulling force when pulling. The distance S from the positioning point of the fixed traction cable of the heel support arm 203 to the heel is 1 cm-5 cm, preferably 2 cm-4 cm, and more preferably 2.5 cm˜3.0 cm, as shown in FIG. 3. According to theory, due to the effect of the force arm, the longer the distance between the connection point of the traction cable and the lower bracket 20, the smaller the traction force required, as shown by the dotted line in FIG. 3, however, if the distance is too long, the heel will not be able to touch the ground normally.

The lower bracket 20 also includes a heel strap 60, which is located under the heel of the human body and plays a role in supporting and positioning the foot, in the preferred embodiment, the heel strap 60 is in the shape of a sheet, and its two ends are connected to the rearward positions of the front inner and outer support arms 201 and 202 or to the U-shaped ends of the heel support arm 203 or to the connection points between the heel support arm 203 and the front inner and outer support arms 201 and 202. In one embodiment, a baffle 2031, 2032 extends downward from two U-shaped ports of the heel support arm 203, and the heel strap 60 is connected to the lower ends of the two baffles 2031, 2032, the baffles 2031 and 2032 simultaneously function to position the feet, thereby enhancing the fixation and positioning of the human body's feet in the left and right directions. In the preferred solution, through holes are provided on the bodies of the two baffles 2031 and 2032 for installing and fixing the heel straps, while also achieving breathability, weight reduction, and material reduction. In this embodiment, the heel strap 60 is in the shape of a sheet, which has a wider contact surface with the bottom of the user's shoe, is less destructive to the shoe, increases wear resistance, improves quality, and disperses pressure, thereby increasing the using experience and comfort of the user.

The present invention also includes a heel connection cover 50, the heel connection cover 50 extends downward from the center point of the heel support arm 203 and includes a U-shaped thin plate, and the lowest part of the below part is at a certain distance from the bottom surface of the user's shoe sole, the top edge is the junction line between the user's shoe fabric and the sole, so that the heel connection cover 50 is low enough but at a certain distance from the ground, so that the heel connection cover 50 is pressed against the sole of the user's heel to achieve fixed support for the user's shoes, prevents the user's feet from moving forward and backward, and will not let the user feel the hard U-shaped thin plate, which affects the power-assist effect and comfort.

A convex thin support piece 2011, 2021 extends inward from the front end of the front inner and outer support arms 201 and 202 of the lower bracket 20, which is located on the sole of the user's shoe to support, position and fix the user's foot, and when the lower bracket 20 rotates and swings upward, it provides upward support thrust to the user's feet, pushing the user's feet upward to perform dorsiflexion movements; when the lower bracket 20 rotates and swings downward, the foot strap connected by 2031 and 2032 lift the user's heels and presses the user's foot down toward the ground, providing assistance for the user's foot to perform plantar flexion movements. In another preferred embodiment, the support pieces 2011 and 2021 are located close to the toe joints of the human body. Preferably, the support pieces 2011 and 2021 are made into narrow sheets to reduce the foreign body feeling in the sole of the user's foot when the forefoot touches the bottom.

In the embodiment of the present invention, the two ends of the foot strap 40 are respectively fixedly connected to the front and inner and outer support arms 201 and 202 of the lower bracket 20 and are located on the human foot to support, position and fix the user's feet; when the lower bracket 20 rotating and swinging downward, it provides downward pressure on the user's foot and provides assistance for the user's foot to perform plantar flexion movements. In another preferred embodiment, the foot strap 40 is located between the ankle and the support pieces 2011 and 2021, and a more preferred solution is to be located behind the toe joint of the human body.

As shown in FIGS. 1, 4, and 5, in the embodiment of the present invention, the leg strap 30 includes: a fixed strap 31, and an adjusting strap 32 fixedly connected to one end of the fixed strap, the other end of the fixed strap 31 is provided with a connecting portion 33, the other end of the adjusting strap 32 is provided with a connecting piece 34 that is detachably and fixedly connected to the connecting portion 33. An adjustment member 35 is provided on the adjusting strap 32 to adjust the expansion and contraction of the adjusting strap 32, the adjustment member 35 is preferably a winch, which can be retracted or released to tighten and relax the strap, the adjustment member 35 is arranged on the end of the adjusting strap 32 which connects the fixed strap 31. The connecting portion 33 and the connecting piece 34 are removably and fixedly connected, preferably by matching a magnetic buckle with a magnetic buckle base, the magnetic buckle and the magnetic buckle base are provided with buckle that engage with each other, it is stuck along the transverse direction of the leg strap 30 and cannot be opened, but it can be easily opened along the longitudinal direction of the leg strap 30. The connecting piece 34 is also provided with a release portion 36, which is a hand strap, by pulling the release portion 36 upward, the connecting piece 34 can be released from the connecting portion 33. The fixed strap 31 is provided with fixing portions 311 and 312 that are respectively fixedly connected to the upper ends of the upper inner and outer brackets 121 and 122 of the upper bracket 10, preferably, the fixing portions 311 and 312 are one or more through holes, which by screws pass through the through holes to fix the fixed strap 31 and the upper ends of the upper inner and outer brackets 121 and 122, multiple through holes satisfy the adjustment of the lower legs of different sizes.

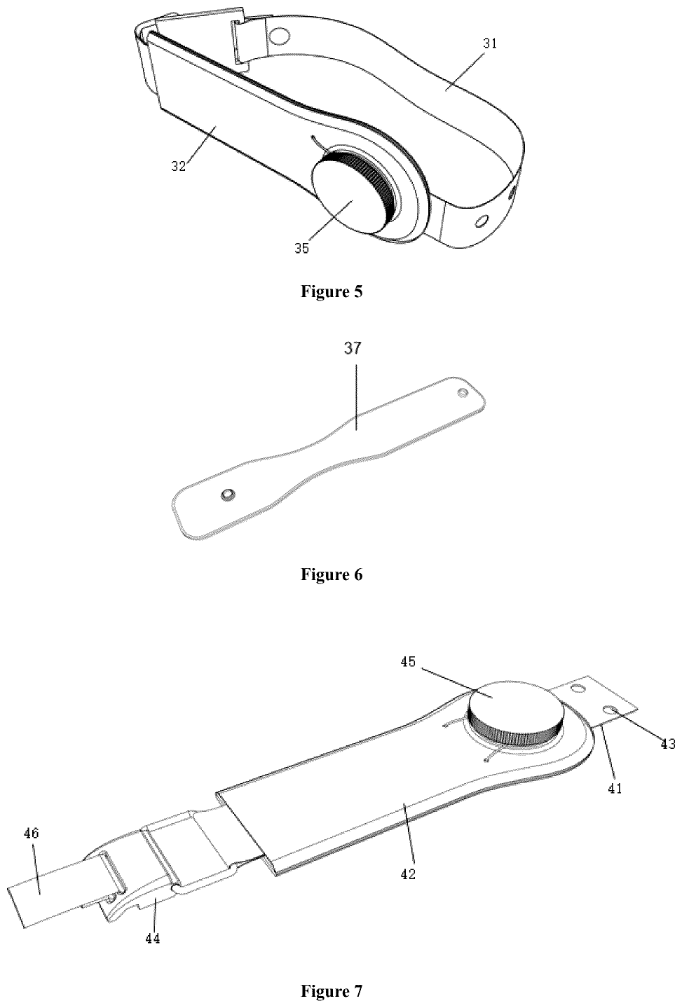

In another preferred embodiment, a gasket 37 is also included, as shown in FIG. 6, which is a schematic diagram of the gasket in this embodiment. The gasket 37 includes a comfortable and soft layer that fits the human calf and a waterproof layer connected to the leg strap 30. The waterproof layer and the fixed strap 31 of the leg strap 30 are fixed with Velcro and/or snap button, the preferred solution is that the Velcro is located in the middle and the snap button are located at the ends to fix the gasket from the middle and both ends to prevent it from sliding and increase the user's comfort.

The leg strap can be easily adjusted to a suitable size according to the size of the customer's calf through the adjusting strap, and the leg strap can be easily and quickly installed and released through the magnetic buckle. Through the gasket, the protection of the calf is increased and the user's comfort is increased. At the same time, through different options of mounting and fixing through holes, the size of the straps can again be fine-tuned.

As shown in FIGS. 1 and 7, in the embodiment of the present invention, the foot strap 40 includes: a fixed strap 41, an adjusting strap 42 fixedly connected to one end of the fixed strap, and the other end of the fixed strap 41 is provided with a connecting portion 43 fixedly connected to one of the front inner and outer support arms 201, 202 of the lower bracket 20, and the other end of the adjusting strap 42 is provided with a connecting piece 44 which is detachably fixedly connected to a connecting seat (not shown) provided on the other support arm of the front inner and outer support arms 201, 202. The adjusting strap 42 is provided with an adjustment member 45 for adjusting the expansion and contraction of the adjusting strap 42. The adjustment member 45 is preferably a winch, which can be retracted or released to tighten and relax the strap, the adjustment member 45 is arranged on the end of the adjusting strap 42 which connects with the fixed strap 41. The connecting piece 44 is removably and fixedly connected to the connecting seat provided on the support arm, it is preferred that the magnetic buckle with magnetic force matches the magnetic buckle base, the magnetic buckle and the magnetic buckle base are provided with mutually engaging buckles which is stuck along the transverse direction of the foot strap and cannot be opened, but can be easily opened along the longitudinal direction of the foot strap 40. The connecting piece 44 is also provided with a release portion 46, in this embodiment, the release portion is a hand strap, by lifting the release portion 46 upward, the connecting piece 44 can be released from the connecting seat. In a preferred solution, the connecting portion of the fixed strap 41 is fixedly connected to the front inner support arm 201 of the lower bracket 20, and the connecting seat is provided on the front outer support arm 202 of the lower bracket 20.

The foot strap 40 can be easily adjusted to a suitable size according to the size of the customer's foot shoes through the adjustment strap, and the foot strap can be easily and quickly installed and released through the magnetic buckle structure.

In another preferred embodiment, the leg strap 30 is located below the human body's knee when worn on the human body's calf, so as to better release the human body's joint movement and reduce the restriction of the human body's joint movement by the exoskeleton support.

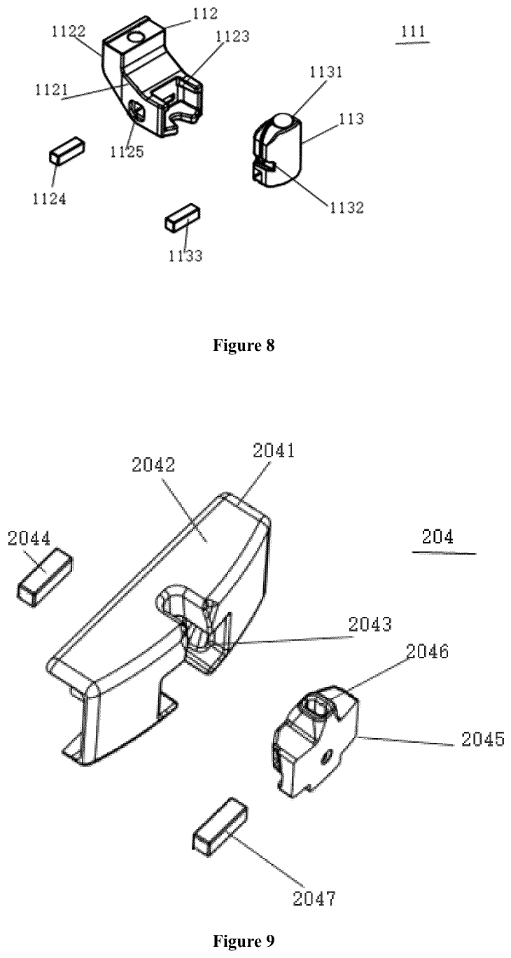

In another embodiment of the present invention, the body 11 of the upper bracket 10 is provided with a cable installation part 111 for fixing and installing traction cables and/or transmission lines, as shown in FIG. 8, the cable installation part 111 of this embodiment is exploded diagram. The cable installation part 111 includes an upper bracket connector 112 fixed on the body 11 and a mounting block 113 for transmitting and fixing the traction cable, the mounting block 113 is detachably and fixedly connected to the upper bracket connector 112.

The cable installation part 111 includes an upper bracket connector 112 that is installed and fixed on the body 11, the upper bracket connector 112 includes a bracket connector body 1121 that is fixed on the body 11, a boss 1122 extends upward from the bracket connector body 1121, used to support and fix external sensors and other components; the bracket connector body 1121 extends backward to form a rear boss, which is provided with a rear opening, a slot with partial openings on the top surface and bottom surface, forming a slot 1123 with a left and right walls and a top surface and bottom surface with openings, and a guide rail (not shown) on the inside of the left and/or right wall. The cable installation part 111 also includes a magnetic block 1124 embedded therein, which is embedded in the bracket connector body 1121, the preferred solution is to provide an opening hole 1125 on the left or right wall of the slot 1123 for the magnetic block 1124 to be embedded in. The cable installation part 111 also includes a mounting block 113. The mounting block 113 includes a through hole 1131 for positioning and guiding the transmission and traction cable, the through hole 1131 communicates with the top surface and bottom surface opening of the slot 1123. The mounting block 113 is provided with a fixing slot 1132 for matching the guide rail. The magnet block 1133 is embedded in the lower part of the mounting block 113, a preferred solution is to open an opening (not numbered) in the lower part of the mounting block 113 for the magnet block 1133 to be embedded. When installation, the mounting block 113 is inserted into the slot 1123, and the guide rail is inserted into the fixing slot 1132. Due to the support, blocking, and positioning of the upper, lower, left, right, and front walls of the slot 1123 and the guide rails and fixing slots 1132, the mounting block 113 is positioned and fixed in the slot 1123. Through the attraction of the magnet blocks 1124 and 1133 embedded in the upper bracket connector 112 and the mounting block 113, installation and fixation are quickly completed. Preferably, the guide rail and the fixing slot 1132 have a certain inclination angle to prevent the mounting block from falling off the slot and sliding out of the bracket connection part due to the pulling force and pressure of the pulling wire during the user's use. Preferably, the inclination angle of the guide rail and the fixing slot is upwardly inclined, and the inclination angle ranges from 5° to 10°. When disassembling, just pull the mounting block 113 outwards with force to overcome the attraction of the magnetic block, and the mounting block can be easily disassembled. In this embodiment, the slot, the guide rail, the fixing slot and the magnetic block are matched to achieve quick installation and disassembly of the bracket connection part and the installation part.

The magnetic blocks 1124 and 1133 are magnets that attract each other magnetically.

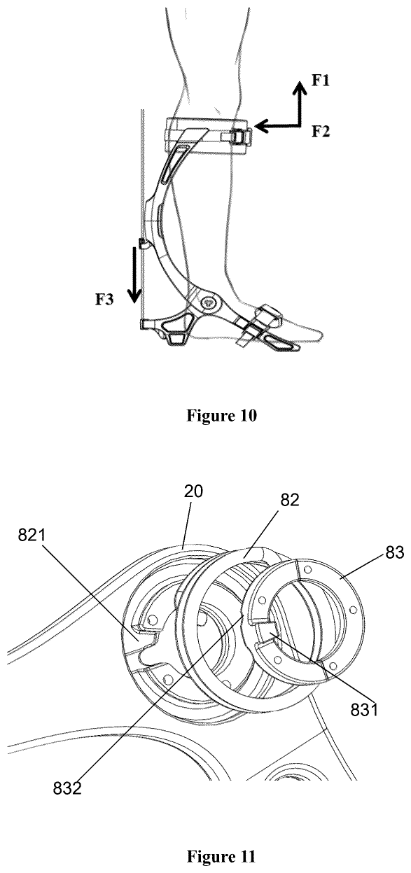

In another embodiment of the present invention, the heel support arm 203 of the lower bracket 20 is provided with a cable installation part 204 for fixing and installing traction cables and/or transmission lines. As shown in FIG. 9, it is decomposition diagram of the cable installation part 204 of this embodiment. The installation part 204 includes a lower bracket connector 2041 fixed on the heel support arm 203 and a mounting block 2045 for transmitting and fixing the traction cable. The mounting block 2045 is detachably and fixedly connected to the lower bracket connector 2041.

The lower bracket connector 2041 includes a bracket connector body 2042, one side of which is fixed on the heel support arm 203, the preferred solution is located in the middle of the heel support arm 203; the other side of the bracket connector body 2042 is provided with a slot that communicates up and down, forming an inserting slot 2043 with partial openings on the left and right walls, and on the upper and lower walls. The preferred solution is that the inserting slot 2043 is provided at the middle position on the side opposite to the fixed side. The lower bracket connector 2041 also includes a magnet block 2044 embedded therein. The cable installation part 204 also includes a mounting block 2045. The mounting block 2045 is used to fixedly connect external traction cables, and includes a through hole 2046 for positioning and guiding the transmission traction cable. The traction cable passes through the through hole 2046 and is fixed on the mounting block 2045. A shoulder is provided on both sides of the upper end and lower end of the through hole 2046 in the up and down direction, forming a convex shape at the upper and lower ends to facilitate easy operation during installation and removal. The mounting block 2045 has a magnetic block 2047 embedded therein. During installation and mating, the mounting block 2045 is inserted into the inserting slot 2043, and is limited by the support and obstruction of the upper, lower, left, right and front walls of the inserting slot to position and fix the mounting block 2045 in the inserting slot 2043. Through the attraction of the magnet blocks 2044 and 2047 embedded in the lower bracket connector 2041 and the mounting block 2045, installation and fixation are quickly completed. When disassembling, just pull the mounting block 2045 outwards with force to overcome the suction force of the magnetic block, and the mounting block can be easily taken out. In this implementation, the fast installation and disassembly of the bracket connection part and the installation part is achieved through the matching of the inserting slot and the magnetic block.

The magnetic blocks 2044 and 2047 are magnets that attract each other magnetically.

The upward traction force of the flexible traction cable (not numbered) drives the lower bracket to perform in-plane dorsiflexion and plantar flexion rotation movements to achieve assisted lower limb motor function rehabilitation.

The exoskeleton supports no higher than a human knee. The flexible traction cable is fixedly installed through the cable installation parts of the upper bracket 10 and the lower bracket 20. When the traction cable receives upward traction force, the traction cable pulls the heel support arm 203 of the lower bracket 20 to rotate upward, thereby driving the entire the lower bracket and the human body's feet fixed on the lower bracket move upward to provide assistance for the upward lifting movement of the human body's lower legs and feet. During the upward movement, the torsion spring 82 of the rotation part 80 is rotated upward by the lower bracket 20 to generate a torsion force, when the traction cable stops providing traction force, and the torsion force of the torsion spring 82 is greater than the traction force, the torsion spring 82 moves downward to the lower bracket 20, the accumulated torsion provides downward pressure to the lower bracket 20, driving the lower bracket to rotate downward, as shown in FIG. 10, these are various reaction forces generated during use in the present invention, and F1 is upward friction, F2 is the inward pressure, F3 is the downward traction.

The present invention reduces the height of the overall structure of the bracket by arranging a curved upper bracket structure, the upper bracket structure located below the knee cooperates better with the human body, there are no parts on the side of the human body's calf, which reduces the possibility of collision, it does not affect other activities when worn, enhancing the wearing experience and comfort.

The upper bracket of the X-shaped structure of the present invention is integrally formed, which reduces the connection between the components and improves the strength of the overall structure; at the same time, the upper and lower inner and outer brackets can be made thinner and smaller, which can also achieve the same effect on the force withstand, reduce materials, reduce weight, and reduce costs; at the same time, the X-shaped structure is symmetrical, and the force generated on the bracket and the assistance provided by the bracket are symmetrical, achieving a better balanced assistance effect. The body at the intersection of the upper bracket of the X-shaped structure provides an install fixed platform for other parts such as the traction cable and/or transmission line, sensor, processors, controllers to connect and fix these other parts positioned on the body, the traction cables and/or transmission lines of the exoskeleton support are connected and fixedly positioned through the body of the X structure, so that the traction cables and/or transmission lines are located behind the calf, making the structure of the overall exoskeleton frame more compact and concise.

Based on the principle of bionic ankle joint movement, the present invention arranges flexible traction cables on the back side of the human body's calf, and uses torsion springs to assist dorsiflexion, which can simplify the structure and is conducive to the conduction of traction force, which is better than arranging it on both sides of the calf.

The present invention fixes the upper bracket on the human body's calf through leg straps, and fixes the traction cable on the bracket and absorbs the reaction force of the traction cable by the bracket, avoiding the reaction force of the traction cable acting directly on the calf and causing injury to the human legs, at the same time, soft leg straps are used to reduce the damage to the legs caused by the reaction force of the traction cable and increase comfort. The adjustment part of the leg strap allows the strap to be adjusted according to the size of the user's calf, meeting the needs of users of different sizes; the magnetic buckle structure of the leg strap makes it convenient and safety for users to fasten and disassemble when wearing it.

The present invention quickly installs and disassembles the traction cable through the magnets of the cable installation part and the upper and lower quick release connectors, which is convenient for users to operate and use, so that the bracket, auxiliary exoskeleton equipment controller, and cables can be conveniently separate packaging during transportation, can reduce the equipment loss and the cables' easily damaged and broken caused by the cables and brackets being connected together during transportation, providing safety during transportation and extending the service life of the equipment.

The foot of the present invention uses a heel connection cover, a foot strap, and a heel strap structure to position the lower bracket, which effectively prevents the human foot from shifting forward, backward, left, and right on the lower bracket, and prevents the lower bracket from loosening, ensures safety and stability during use. The adjustment part of the foot strap allows the strap to be adjusted according to the user's shoe size, meeting the needs of users of different sizes; the magnetic buckle structure connection method of the foot strap makes it convenient and safe for users to put on and remove sex.

The rear side of the lower bracket is positioned using a heel connection cover, which is placed at the Achilles tendon of the foot and has less impact on the human body. The upper edge of the heel connection cover used for positioning is flush with the gap between the shoe knitted fabric and the sole, when the connection cover needs to squeeze the shoe forward due to external force, all the force is transmitted to the sole instead of directly against the user heel, greatly improving user comfort.

The front end of the lower bracket is positioned using an adjustable foot strap, the closer the foot strap is to the front end of the foot, the better the positioning effect, if the foot strap is placed at the toe position, during exercise, it will affect the mobility and comfort of the toes, affecting the use effect, it is the best solution to move the foot strap position backward and position it behind the toe joint.

The bottom surface of the foot uses a heel strap and a support sheet on the lower bracket to limit the Z-direction freedom of the bracket. The heel strap structure replaces the existing lower bracket step structure, such as the heel bottom adopts a rigid structure, the user will have a noticeable tactile sensation, which affects the comfort of use; the closer the lower bracket support piece is to the front end, the better the limiting effect is, and the force it bears when the torsion spring acts is the smallest, however, considering that the toes have a certain degree of mobility in the working state, not particularly good at withstanding high forces, including taking into account the shape and structure of the shoe, affects the use effect, therefore, it is preferred that the lower bracket support piece limiting structure is placed close to the toe joint.

1. An ankle-assisting exoskeleton support, wherein the ankle-assisting exoskeleton support includes an upper bracket and a lower bracket; the lower end of the upper bracket is rotatably connected to the rear end of the lower bracket, and the upper bracket is fixed to the calf through a connecting belt for being mounted on the calf of the human body, the upper end of the upper bracket is located on the inner and outer sides of the human calf and below the knee; the lower bracket is set on the human foot to provide assistance for the dorsiflexion and plantar flexion movement of the human foot;
the upper bracket includes a body, a pair of upper inner and outer brackets with curvature extend upward and outward from the upper end of the body; a pair of lower inner and outer brackets with curvature extend downward and outward from the lower end of the body, the upper bracket forms an X-shaped bracket structure with bending curvature.

2. The ankle-assisting exoskeleton support according to claim 1, wherein the bending curvature of the upper bracket is defined as follows: the maximum bending point is located on the body, the upper end point of the upper inner and outer brackets is located at the middle and rear position of the inner and outer sides of the calf when the user wears it; the lower end point of the lower inner and outer bracket is located at the user's ankle joint position or on the axis of dorsiflexion and plantar flexion degrees of freedom when the user is using it.

3. The ankle-assisting exoskeleton support according to claim 2, wherein the upper bracket is integrally formed, and its bending curvature is: the distance from the lowermost end to the uppermost end of the upper bracket is 20 cm-50 cm; the distance between the middle part of the body and the straight line connecting the uppermost end and the lowermost end is 5 cm-15 cm.

4. The ankle-assisting exoskeleton support according to claim 1, wherein the lower bracket includes a front inner and outer support arm and a heel support arm, the heel support arm is in a U shape matching the shape of the human heel, the two ends of the U shape are connected to the rear ends of the front inner and outer support arms, the intersection point of the heel support arm and the front inner and outer support arms is the connection point between the lower bracket and the upper bracket, forming the joint rotation part of the exoskeleton support.

5. The ankle-assisting exoskeleton support according to claim 4, wherein the lower bracket includes a foot strap, and the two ends of the foot strap are respectively fixedly connected to the front inner and outer support arms of the lower bracket, and are located on the instep of the human foot to support, position, and fix the user's feet; the front end of the front inner and outer support arms of the lower bracket each extends inwardly with a convex thin support piece, which is located on the sole of the user's shoe to support, position and fix the user's foot, and when the lower bracket rotates and swings upwards and downwards, respectively providing upward support thrust to the user's feet and downward pressure to the ground.

6. The ankle-assisting exoskeleton support according to claim 5, wherein the lower bracket further includes a heel strap located under the heel of the human body, the heel strap is in the shape of a sheet, and its two ends are connected to the rear positions of the front inner and outer support arms or to the U-shaped two ends of the heel support arm or to the connection between the heel support arm and the front inner and outer support arms.

7. The ankle-assisting exoskeleton support according to claim 6, wherein a baffle extends downward from both ends of the U-shape of the heel support arm, and the heel strap is connected to the lower ends of the two baffles.

8. The ankle-assisting exoskeleton support according to claim 4, wherein the ankle-assisting exoskeleton support further includes a heel connection cover, which extends downward from the center point of the heel support arm and includes a U-shaped thin plate that abuts on the sole of the user's heel.

9. The ankle-assisting exoskeleton support according to claim 4,
wherein the joint rotation part realizes the relative free rotation and reset of the upper and lower brackets, and includes an outer bearing seat, a torsion spring, an inner bearing seat, a bearing, and a bearing cover; the outer bearing seat is fixed to the outer side of the lower end of the upper bracket, the torsion spring, inner bearing seat, bearing, and bearing cover are installed in sequence between the inside of the lower end of the upper bracket and the lower bracket.

10. The ankle-assisting exoskeleton support according to claim 6, wherein the body of the upper bracket is provided with an installation portion for installing and fixing the traction cable; and the heel support arm of the lower bracket is provided with an installation portion for installing and fixing the traction cable.
